(19) United States
(12) Patent Application Publication
(10) Pub. No.: US 2026/0260491 A1
(43) Pub. Date: Sep. 3, 2026

(54) ARTIFICIAL-INTELLIGENCE (AI) SYSTEM FOR GENERATING EVENT ANALYTICS

(71) Applicant: Arash Kia, Portland, OR (US)

(72) Inventor: Arash Kia, Portland, OR (US)

(21) Appl. No.: 19/288,179

(22) Filed: Aug. 1, 2025

Related U.S. Application Data
(60) Provisional application No. 63/678,494, filed on Aug. 1, 2024.

(51) Int. Cl. G06V 20/40; G06V 30/19; G06V 40/10

(52) U.S. Cl. CPC G06V 20/44; G06V 30/19; G06V 40/10

(57) ABSTRACT

An embodiment of a system includes an image-capture device and a computing circuit. The image-capture device is configured to capture an image of a participant identifier as a participant carrying the participant identifier crosses a finish line of an event course. And the computing circuit is configured to determine, in response to the captured image of the participant identifier, an identity of the participant, and to store, in a memory, the determined identity of the participant and a time at which the participant crossed the finish line.

### CLAIM OF PRIORITY AND CROSS-REFERENCE TO RELATED APPLICATIONS

This application claims priority to U.S. Provisional Patent Application Ser. No. 63/678,494 filed Aug. 1, 2024.

This application relates to: U.S. patent application Ser. No. 19/209,013 filed May 15, 2025, which is a continuation of U.S. Pat. No. 12,322,216 filed Oct. 24, 2022, which is a continuation of U.S. Pat. No. 11,501,582 filed Nov. 30, 2020, which claims benefit of U.S. Provisional Application 62/942,156 filed Dec. 1, 2019; U.S. patent application Ser. No. 17/841,507 filed Jun. 15, 2022, which claims benefit of U.S. Provisional Application Ser. Nos. 63/210,922 filed Jun. 15, 2021 and 63/299,340 filed Jan. 13, 2022; U.S. patent application Ser. No. 19/016,617 filed Jan. 10, 2025, which claims benefit of U.S. 63/620,157 filed Jan. 11, 2024 and which is a CIP of U.S. patent application Ser. No. 17/971,983 filed Oct. 24, 2022, which is a CIP of U.S. Pat. No. 11,501,582 filed Nov. 30, 2020, which claims benefit of U.S. Patent Application Ser. No. 62/942,156 filed Dec. 1, 2019, and which is a CIP of U.S. patent application Ser. No. 17/841,507 filed Jun. 15, 2022, which claims benefit of U.S. Provisional Application Ser. Nos. 63/210,922 filed Jun. 15, 2021 and 63/299,340 filed Jan. 13, 2022, and which claims benefit of U.S. Provisional Application Ser. No. 63/678,494 filed Aug. 1, 2024.

This application hereby incorporates by reference the above-listed applications in their entireties as if fully set forth herein.

### COPYRIGHT NOTICE

This disclosure is protected under United States and/or International Copyright Laws. @ 2022*. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### SUMMARY

In an embodiment, a system uses Bluetooth® and/or Wi-Fi® technology to identify participants such as athletes competing in, or otherwise participating in, an event or a contest such as an athletic event or athletic contest. Components of the system include beacons, software applications residing in the cloud, and gateways. Beacons transmit their identifications (e.g., the IDs of the athletes carrying the beacons) in the Bluetooth® band, and each gateway picks up the IDs of one or more beacons in close proximity to the gateway. Beacons are attached to the participants (e.g., pinned onto their shirts, strapped to their wrists) to identify the participants individually, and gateways are distributed along the competition course (e.g., along a running-race course) to pick up the signals from the beacons. Where the event is a running race, an operator (e.g., a race organizer or sponsor) specifies (1) the course map, and (2) the location of the dropped gateways on the course. While the race is ongoing, the gateways, the positions of which are fixed, track the position of each runner over time by tracking the signal emitted by the runner's beacon. From the position-and-corresponding-time data for a runner, a system, such as a cloud computer system, can calculate metrics (e.g., analytics) such as the runners average speed or an average pace at any particular stretch along the course. With additional data (e.g., a runner's height, weight, the wind direction and velocity), a system, such as a cloud computer system, can calculate additional metrics (e.g., performance vs. body weight, performance vs. outside temperature), for example, by leveraging AI.

In an embodiment, a system is configured to use humanoid (e.g., facial) recognition, optical-character recognition (OCR), or both humanoid recognition and OCR instead of, or in addition to, Bluetooth® technology to identify athletes competing in an event or a contest. Other than being so configured, the system can be similar to the embodiment of the system described in the preceding paragraph. Or the system can omit the beacons and at least some of the gateways to reduce a cost of the system or a cost of implementing the system.

In an embodiment, a system includes an image-capture device and a computing circuit. The image-capture device is configured to capture an image of a participant identifier as a participant carrying the participant identifier crosses a finish line of an event course. And the computing circuit is configured to determine, in response to the captured image of the participant identifier, an identity of the participant, and to store, in a memory, the determined identity of the participant and a time at which the participant crossed the finish line.

### BRIEF DESCRIPTION OF THE DRAWING FIGURES

FIG. 1 is a map of an event course with gateways positioned at checkpoints along the course, according to an embodiment.

FIG. 2 includes a map of an event course with gateways positioned at checkpoints along the course, an elevational map of the event course, and, for an event participant, a score card generated through data captured by the gateways deployed along the event course, according to an embodiment.

FIGS. 3A and 3B are diagrams of an imaging and gateway system and participants at a finish line of an event course, according to an embodiment.

FIG. 4 is a diagram of the imaging and gateway system and finish line of FIG. 3B and of components of a processing system coupled to the imaging and gateway system, according to an embodiment.

FIG. 5 is an AI prompt that taps into a knowledge base generated in response to results of one or more events and providing analytics and analysis back to a user, according to an embodiment.

FIG. 6 is a functional block diagram of an electronic system that can be used as the imaging and gateway system of FIG. 4 or otherwise that can be used to perform one or more of the operations or functions described herein, according to an embodiment.

### DETAILED DESCRIPTION

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

In an embodiment, a system is configured to collect data regarding an event (e.g., an athletic event such as a running race) and to generate, for event participants (e.g., runners) and from the collected data, analytics regarding each participant relative to the event, and regarding the event itself. The system includes first devices (typically wireless devices), called beacons, associated with the event participants for identifying, electronically, the participants as they participate in the event, second devices (typically wireless devices), called gateways, distributed around the geographic region where the event takes place and configured to receive raw data from the beacons and to process at least some of the raw data, and one or more computing machines (e.g., cloud-based) configured to receive at least some of the raw data and the processed data from the gateways, to analyze the raw and processed data, to maintain a database of a number of similar events and participants of those events, and to generate analytics in response to the analyzed data and data from the database. The one or more computing machines may perform one or more of these operations by executing, or otherwise using, artificial intelligence (AI).

For example, a 5K race includes five hundred participants. Each participant wears, or otherwise carries, a Bluetooth® compatible beacon that transmits information such as a unique identity (ID) of the participant. The beacon also can transmit other information including participant location (e.g., if the beacon includes a GPS locator), air temperature or humidity in the vicinity of the beacon, or a number of steps taken by the participant over one or more periods of time. Due to popularity of RFID readers and scanners used in participatory athletic events, a Bluetooth® beacon could be armed or loaded with an RFID tag, which could make the beacon readable by both Bluetooth® and RFID scanners/gateways. That is, in an embodiment, a beacon can be capable of identifying an event participant using Bluetooth® signals, one or more passively read RFID tags, or both Bluetooth® signals and one or more passively read RFID tags. Furthermore, such a beacon can be mounted, or otherwise attached, to a slap band or slap bracelet (also called a snap bracelet) to facilitate wearing of, and removal of, the beacon by an event participant. Alternatively, instead of, or in addition to, Bluetooth® beacons, one can use OCR to read a participant's identification number and other data from a bib worn by the participant.

The gateways, which are distributed along the racecourse (e.g., one gateway every one hundred meters along the racecourse), are configured to receive the signals (e.g., Bluetooth® signals) from the beacons as the beacons pass by the respective gateways. For example, a gateway may be able to recover data from a signal received from a beacon while the beacon is within, e.g., thirty meters of the gateway.

In an embodiment, each gateway can perform some analytics, like determining an average speed or average velocity of a participant as he passes the gateway. And where the gateways can communicate with one another or with a common computing circuit, each gateway (alternatively the common computing circuit), can perform other analytics like determining a participant's leg/split times.

In an embodiment, a gateway can be an electronic circuit that includes a processing circuit (e.g., a microprocessor or microcontroller) and a Bluetooth® transceiver (and/or possibly an RFID tag reader or Wi-Fi® transceiver). For example, a gateway can include a Raspberry Pi® microcontroller that is programmable, or that otherwise is configurable, to perform a variety of functions or operations including one or more of the functions or operations described herein.

In a similar embodiment, microcontroller-based gateways are deployed on a participatory athletic event course to capture data that can determine the crossing times of the participants at points of interest (e.g., checkpoints distributed uniformly or nonuniformly along the event course). The data can be generated by beacons that communicate with the gateways using Wi-Fi®, Bluetooth® (e.g., low-energy Bluetooth® (BLE)), RFID, humanoid recognition, OCR, or by any other devices or systems operating on public or commercial bands and that can be used as beacons. For example, a system can use the Bluetooth® band of communication by using Bluetooth® gateways and Bluetooth® beacons to individually identify and determine the crossing time of each participant at the aforementioned checkpoints. The system can use the data captured from these intermediary checkpoints on a race course to create a new generation of race score cards for each participant and to perform analytics using an AI engine that allows the AI system to access, or otherwise to utilize, a large proprietary knowledge base of performances by event participants (e.g., race runners) from a wide range of backgrounds, builds, makeups, age, and conditioning at participatory endurance events to provide customized analytics to each individual user (e.g., event participant) of the AI system.

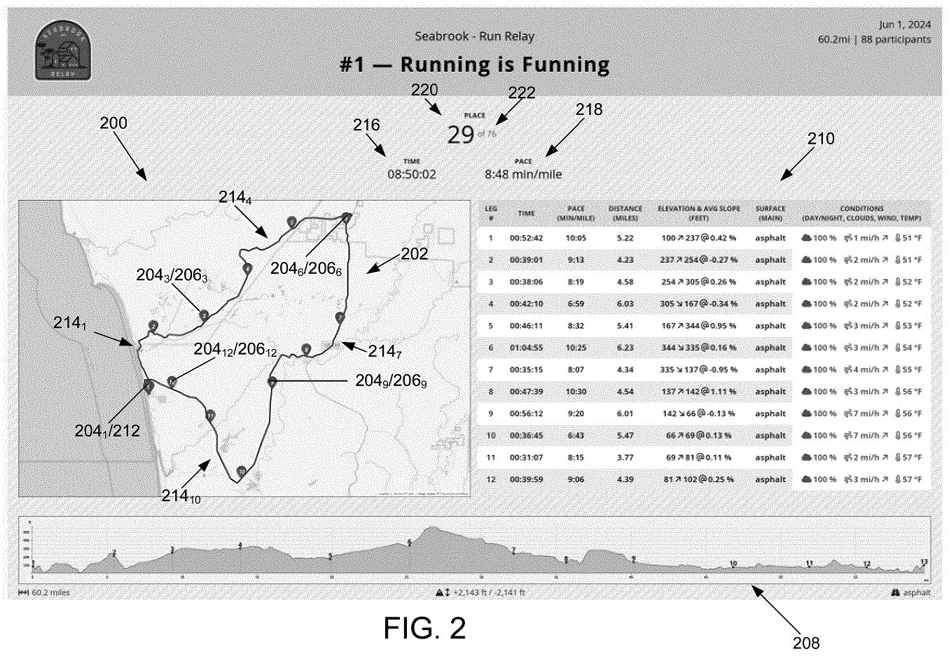

Bluetooth® gateways can be used to capture Bluetooth® signals from any device with a Bluetooth® transmitter, which device can be configured as a beacon. In an embodiment, the Bluetooth® gateways can calculate the crossing times of the participants, communicate and transmit this data to the cloud, and store the data on the local gateway so as to preserve the information in case of loss of connectivity. In an embodiment, a microprocessor or microcontroller is used to supplement or to replace the gateway (e.g., the gateway can include the microprocessor or microcontroller). And a small computer, such as a Raspberry Pi®, an Nvidia computer integrated circuit (IC), or a similar device can be used as a microprocessor or microcontroller. A Raspberry Pi®, acting as a gateway, can store almost unlimited (e.g., limited by available volatile memory on the Raspberry Pi®) Bluetooth® data (e.g., data from one or more of the Bluetooth® beacons) onboard, transfer the data to the cloud, and perform functions to sort and process the data with local and customized applications onboard. The data captured and processed by the microprocessor or microcontroller can be used to determine the crossing times of a race participant at checkpoints set along the course. Use of microprocessors or microcontrollers can allow event (e.g., race) organizers to capture data and perform calculations on the data to create a new generation of score cards. An example of such a score card is shown in FIG. 2.

In an embodiment, a computer-based AI system (e.g., an AI engine) can generate a new generation of score cards for the participants of endurance events (e.g., running races), where data from microcontroller-(or microprocessor)-based gateways as described herein can provide a more-detailed breakdown of a participant's performance at an endurance event. By placement of the microcontroller-(or microprocessor)-based gateways along the course (e.g., every ten meters, twenty meters, one hundred meters, kilometer, or mile, or at bottom and/or top of each climb or descent), the AI system can deliver a more-descriptive and -interesting set of data to each participant. A score card can be broken up into a number of legs of the event course, where each leg can have a set of relevant and descriptive indicators such as average slope, elevation change, temperature, wind, or wind direction.

In an embodiment, an AI engine can access a large knowledge base of the performances of participants at the endurance events and can present a participant with an AI command-line interface or prompt to allow the participant to request multivariant analytics, data analysis, basic reporting, or other information. The AI system can include a command-line prompt that refers to an AI-prompt interface that utilizes a knowledge base to perform the tasks and functions requested by the user (e.g., an event participant such as a runner). The knowledge base utilized by the AI system is made up of data from gateways deployed on the course, and a large historical data set of runners from a variety of demographics who opted in to join the knowledge base with one or more of the following: gender, age, height, weight, and/or other physiological or telemetry data such as heart rate (e.g., resting heart rate, just-after-a-race-has-finished heart rate). After each event, the AI system can be used to provide basic statistical reports on finishers, pace, distributions, and variances from norm. One (e.g., a participant in the event) also can prompt the AI system to compare the performance of an individual participant and examine and predict variations of his/her performance by correlating the participant's (e.g., runner's) data to the data stored in a large knowledge base that has been created over a long period of time. The large knowledge base can have data from participants of all ages, backgrounds, body composition, heights, genders, etc. The AI system also can examine, for example, the impact of more or less heat on a particular runner, the impact of more or less body weight on the pace of a particular runner during a climb, or the impact of age on the performance of a particular runner.

In an embodiment, where the event is a running race, the gateways for the Bluetooth® signal detection are relatively inexpensive; therefore, distributing several of them throughout the racing course enables the capture of data from key spots along the course and the creation of reports (e.g., score cards) for runners. If there is a race with a straightaway and a climb, followed by another straightway, one could “drop” a couple of gateways along the straightaways, and have at least a few gateways along the climb to time runners at or near the bottom, at or near the midpoint, and at or near the top of the climb. After the race, a runner's score card can reflect his/her splits for the climb, for the straightaways, and for any race segments or legs with points (e.g., locations) from which the system (e.g., a Bluetooth® system and/or an optical-humanoid-recognition-and-OCR system including the herein-disclosed gateways) captures data. In addition, the system, can monitor, and can include, as part of a score card, surface and environmental conditions such that each leg of a race can have information, including the following data, associated with the leg: localized (to the location of the leg) weather report and/or weather conditions, localized road (or other surface) gradient, highest elevation, lowest elevation, and elevation gradient, and general weather conditions for the entire course.

Using an embodiment of an AI system (automated, partially automated, or manual) such as disclosed herein can allow generating an embodiment of a scorecard such as disclosed herein without the need to retrieve, manually, weather conditions from a historical database, and can provide for the automatic (e.g., partially automatic, fully automatic) generation of score cards for event participants (e.g., runners in a race) at, for example, the end of the event or when participants complete the event (e.g., some runners are faster, and, therefore, finish the race sooner, than other runners).

Said another way, AI “comes into the picture” after the course data is sent to a computer system, such as the cloud, including a database, which can be a permanent large knowledge base of performances that the database stores and characterizes based on demographics such as participant (e.g., runner) weights, heights, or stride lengths. An AI engine can be configured to cross-correlate the data from one race to the large knowledge base. For example, while cloud-based applications can be configured to publish basic statistics (e.g., average race times, variance and standard deviation in race times) for each leg of a running course, and even to correlate runner weights or heights with runner race times and to generate a plot of the same, an AI engine can be configured to generated feedback that is insightful and better than what humans generally code into a software application. And the AI engine can be easy to engage and may not require knowledge of programming languages or SQL (for databases). A prompt tied to an AI engine can be all that is needed to accomplish the “magic” tied to an AI engine. That is, a user (e.g., a participant in a race) can enter, in response to the prompt, only clear instructions in plain English to get started. For example, an AI engine might calculate, or otherwise determine or generate, some analytics for a person (e.g., event participant) and provide feedback stating “if you gain 10 lbs., I see a new distribution curve for your demographics that looks like this and has a mean of 8 min/mile. But I also see a significant drop in the number of active participants in your demographics if you gain 10 lbs.” Consequently, the AI engine can be configured to provide “that little extra” that humans might not even be searching for.

Furthermore, an example of a scorecard generated by an embodiment of an AI system (e.g., an AI engine) disclosed herein, and of information included on the scorecard, is shown in, and described in conjunction with, FIG. 2.

An embodiment of an AI system can perform a more-detailed analysis where cross correlation and impact to performance can be analyzed using AI. For example, an embodiment of the AI system can correlate event data in a multidimensional way and report the AI system's findings.

In an embodiment, an AI system can perform multi-dimensional analytics. For example, if a runner's pace on hills is better than the pace on hills of most other runners but the runner's flat-terrain pace is not better than the flat-terrain pace of most other runners, then the AI system can cross reference runners of similar build and cross reference data to see if weight or height, or any other parameter, is a potential reason why the runner's flat-terrain pace is relatively poor as compared to the flat-terrain base of most other runners. And the AI system also can analyze environmental conditions such as wind, temperature, or humidity to determine the impact of one or more environmental conditions on a runner's performance.

Another embodiment of the AI system can invite users (e.g., runners) to enter a few personal parameters for more detailed analytics on personal traits. Data such as gender, weight, age, and height are optional to enter but if the user does enter such data, the AI system can use the data to create a knowledge base of performance with the traits and other data entered by the user. This knowledge base is published to the users (e.g., event participants such as runners), e.g., when a runner wonders how he might do on a particular course. Or if a runner has participated in a race and wonders how he might do if he drops or loses 10 lbs. of body weight, then the AI system can provide an estimate based on data available to the AI system. For example, an embodiment of the AI system can have access to a large knowledge base of performance vs. demographics, and using data in this knowledge base, can estimate, or otherwise can determine, how a runner's performance can change with minor changes to the runner's age, weight, or other traits or parameters.

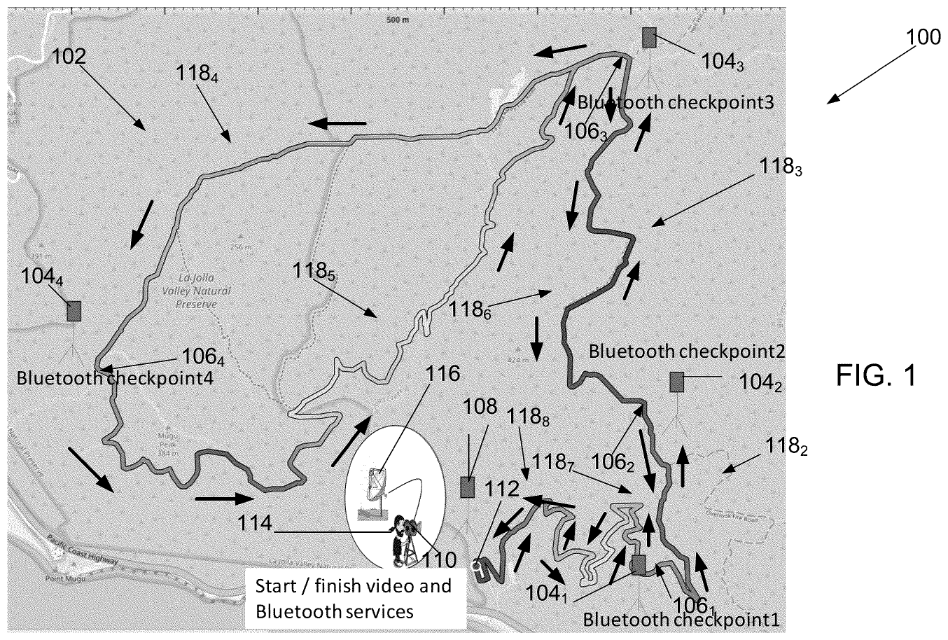

FIG. 1 is a map 100 of an event course 102 with gateways 104₁-104ₙ (e.g., Bluetooth® gateways with n=5 in an embodiment) positioned at checkpoints 106₁-106ₙ along the event course and a gateway 108 with video equipment 110 at a start/finish line 112, according to an embodiment in which the event course is a running-race course (e.g., 1 kilometer (k), 5 k, or 10 k), the gateways can be similar to embodiments of gateways disclosed herein, and the video equipment can be configured to sense when a participant (not visible in FIG. 1) crosses the finish line and to take, automatically, an electronic image or a video of the participant as he/she crosses the finish line; alternatively, a video operator 114 can take the image or video. One or more of the gateways 104 or 108, or the video equipment 110, can be coupled to a cloud-based database or AI engine via a satellite or other internet connection 116 (e.g., wireless broadband or wired (electrical or optical) broadband).

Legs 118 can be defined as the distances, along the event course 102, between consecutive pairs of checkpoints 106 in the direction that the event is conducted (e.g., in the direction that the race is run). For example, a first leg 1181 can be defined as the distance from the start/finish line 112 to the first checkpoint 106₁, a second leg 118₂ can be defined as the distance from the first check point 106₁ to the second checkpoint 106₂, a third leg 118₃ can be defined as the distance from the second checkpoint 106₂ to the third checkpoint 106₃, a fourth leg 118₄ can be defined as the distance from the third checkpoint 106₃ to the fourth checkpoint 106₄, a fifth leg 118₅ can be defined as the distance from the fourth checkpoint 106₄ back to the third checkpoint 106₃, a sixth leg 118₆ can be defined as the distance from the third checkpoint 106₃ back to the second checkpoint 106₂, a seventh leg 118₇ can be defined as the distance from the second checkpoint 106₂ back to the first checkpoint 106₁, and the eighth and final leg 118₈ can be defined as the distance from the first checkpoint 106₁ back to the start/finish line 112. Although certain pairs of the legs 118 (e.g., legs 118₃ and 118₆) define the same section (i.e., between checkpoints 106₂ and 106₃) of the event course 102, because an event participant runs such a pair of legs in opposite directions and at different times during the event, the same section is counted as two legs for event purposes. Furthermore, the different ones of the legs 118₁-118₈ can be the same or different lengths.

Still referring to FIG. 1, in an embodiment during an event, a participant wearing a beacon (e.g., a Bluetooth®, Wi-Fi®, or RFID beacon according to an embodiment disclosed herein, neither the runner nor the beacon visible in FIG. 1) starts the race at the starting line 112 and the gateway 108 records the identity of the participant and his/her starting time and can provide the participant identity and starting time to the cloud via the internet connection 116.

The participant runs toward and past the first, second, and third checkpoints 106₁-106₃, and the respective gateways 102₁-102₃ record the identity of the participant in response to the beacon worn by the participant and record the respective times that the runner arrives at the first, second, and third checkpoints. One or more of the first, second, and third gateways 102₁-102₃ may determine the respective times it took the participant to traverse the first, second, and third legs 118₁-118₃ of the course 102 (these leg times may be called “splits” or “split times”), or may provide, via the internet connection 116, the participant identification and checkpoint times to the cloud for calculation of the first, second, and third leg times.

The participant continues to run from the third check point 106₃ to the fourth checkpoint 106₄ via the fourth leg 118₄, from the fourth check point back to the third checkpoint 106₃ via the fifth leg 118₅, from the third checkpoint back to the second checkpoint 106₂ via the sixth leg 118₆, from the second checkpoint back to the first checkpoint 106₁ via the seventh leg 118₇, and from the first checkpoint to the finish line 112 via the eighth leg 118₈. The respective gateways 102₄-102₁ and the gateway 108 record the identity of the participant in response to the beacon worn by the participant and record the respective times that the runner arrives at the fourth, third, second, and first checkpoints 106₄-106₁ and the finish line 112. One or more of the fourth, third, second, and first gateways 102₄-106₁ or the gateway 108 may determine the respective times it took the participant to traverse the fourth, fifth, sixth, seventh, and eighth legs 118₄-118₈ of the course 102, or may provide, via the internet connection 116, the participant identification and checkpoint times to the cloud for calculation of the fourth, fifth, sixth, seventh, and eighth leg times.

Furthermore, the video system 110, automatically or under control of the operator 114, can take an image or video of the participant and, for example, offer (e.g., offer to sell) the image or video to the participant via a kiosk or other component that is part of the video system or that is separate from the video system (e.g., part of the gateway 108).

The gateways 102₁-102₄ and 108 can provide, for the participant, not only the start time, the times at which the participant arrived at the checkpoints 106₁-106₄, the finish times, and the leg 118₁-118₈ split times, but also can provide other information, such as the local outdoor temperature, weather, time of day, absolute elevation of the checkpoints, respective elevation gradients of the course legs, participant age, participant weight, participant temperature, or participant sex so that an AI engine (not visible in FIG. 1) situated in the cloud and with access to an event database can make calculations (e.g., average course speed, average leg speed) or predictions (e.g., how fast the participant would have run the race had the participant been ten pounds heavier or lighter, had the outdoor temperature or weather been different, had the elevation or elevation gradient been different, or had the time of day been different) according to one or more embodiments described herein.

FIG. 2 includes a map 200 of an event course 202 with gateways 204 deployed at checkpoints 206 along the course, an elevational map 208 of the event course, and, for an event participant (not visible in FIG. 2), a score card 210 generated in response to data captured by the gateways, provided by a cloud database, or both the captured and database data, according to an embodiment.

The gateways 204 can be gateways according to one or more gateway embodiments disclosed herein.

Participants run the event course 202 in a clockwise direction starting at a start/finish line 212 near gateway 204₁ and passing by checkpoints 206₂-206₁₂ and corresponding gateways 204₂-204₁₂ and along legs 214₁-214₁₂.

The scorecard 210 includes, for each leg 214₁-214₁₂, a corresponding time it took the participant to run the leg, the participant's pace during the leg, the length (distance) of the leg, the elevations at the starting point and ending point of the leg and the average slope of the leg, the type of surface(s) (here asphalt) of the event course 202 along the leg, and one or more conditions along the leg including whether it was day or night when the runner traversed the leg, the percent cloudiness, the average wind speed and wind direction, and the air temperature.

The score card 210 also can include the participant's total event time 216, average pace 218 over the entire event, and finishing position 220 relative to the total number 222 of event participants who finished the event.

The gateways 204 can detect and acquire or capture all of the data that one or more of the gateways, or a cloud computing system, uses to calculate the items on the score card 210, or at least some of the data (e.g., weather conditions, whether it is day or night, elevational map 208, or types of surfaces of the legs 214) can be retrieved from a cloud database.

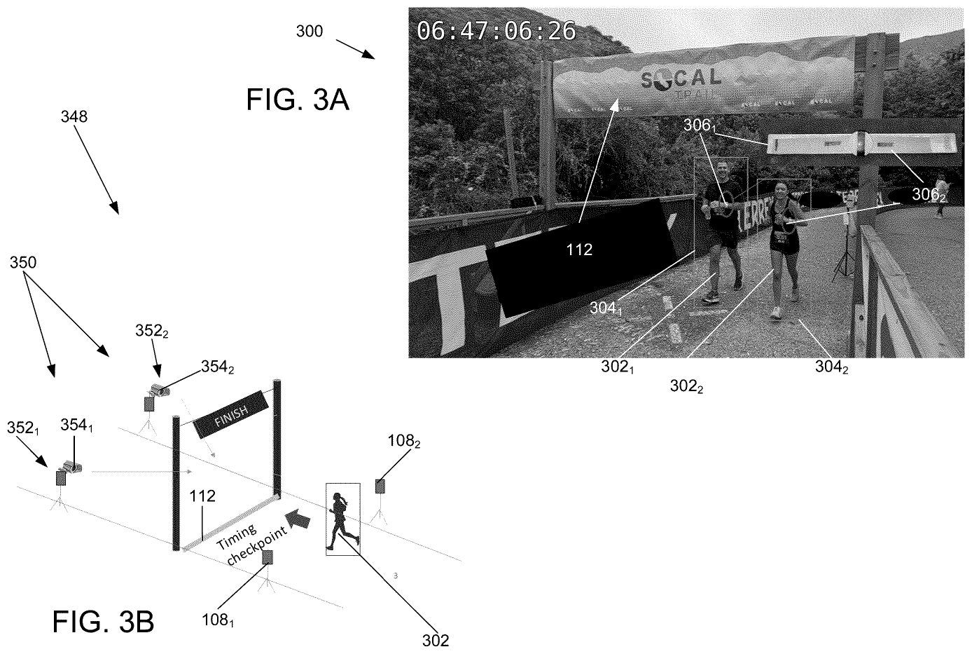

FIG. 3A is an image (e.g., photo) 300 taken by the video system 110 (FIG. 1) at the finish line 112 (FIG. 1) as one or more (two in FIG. 3A) participants 3021-3022 finish the event (e.g., by crossing the finish line), according to an embodiment.

A computing system onboard a video system (e.g., the video system 110 of FIG. 1), or partially or fully located in the cloud, executes a machine-learning model that is trained to detect, and to form bounding boxes 304₁-304₂ around, the participants 302₁-302₂, who are wearing badges, e.g., bibs, 306₁-306₂ (shown in normal-size and magnified views) on their persons (e.g., clothes such as shirts, shorts, hats, or body parts such as arms, legs) so that the side of each bib with participant-identifying data (e.g., printed or etched thereon) is visible to one or more cameras of the video system. A reason that the computing system can be configured to generate one or more bounding boxes, such as the bounding boxes 304, around one or more persons (e.g., humanoids, event participants) in an image can be to demonstrate where the computing system has detected one or more persons in an image; once the computing system detects a person in an image, the computing system then can identify the detected person as disclosed herein.

Each of the bibs 306₁-306₂ can be an embodiment of the Bluetooth®, Wi-Fi®, or RFID beacons described herein with participant-identifying information (e.g., a photo, a name, a participant identification number) printed or otherwise present thereon, or each bib can be separate from the Bluetooth®, Wi-Fi®, or RFID beacon worn by the participant.

Using humanoid (e.g., facial) recognition on the partial (e.g., face) or full body of each participant 302₁-302₂ or on each participant's bib photo, or using another participant—identifying technique such as using optical character recognition (OCR) to derive the participant's identification number from an image of the bib, the video system 110 can identify each participant as he crosses the finish line 112.

The video system 110 then can offer for sale, via a kiosk (not visible in FIG. 3A) or other suitable device, an electronic or printed version of the photo 300 of the participant 302 crossing the finish line (the bounding boxes and the magnified views of the bibs 306 typically are not in the photo offered for sale). Or the video system 110 can offer an electronic version of the photo 300 for purchase via the identified participant's smart phone or other computing device (neither visible in FIG. 3A).

Each participant 302 then can decide whether to purchase the photo 300, and, if he decides to purchase the photo, he can do so via the kiosk, smart phone, or other computing device in a conventional manner.

Furthermore, although, as disclosed herein, one or more gateways 102 (FIG. 1) can identify each participant 302 in response to signals emitted by a Bluetooth® or Wi-Fi® beacon (not visible in FIG. 3A) worn by the participant, in an embodiment the video system 110 can render the gateway 110 (FIG. 1) at the finish line unnecessary by using humanoid-recognition/image-recognition/OCR to identify the participants at the finish line 112 (FIG. 1) and the times at which the participants each cross the finish line. Or versions or nodes of the video system 110 can be installed at each of one or more of the checkpoints 106 (FIG. 1) to render unnecessary the corresponding one or more gateways 102 and the Bluetooth®, Wi-Fi®, or RFID beacons worn by the participants. Such an embodiment can be used, for example, where event organizers wish to reduce a cost of the event by eliminating the need for the participants to wear Bluetooth®, Wi-Fi®, or RFID beacons, which may be relatively expensive.

In an embodiment, participants wear, on their chests or other body part, a bib with a unique participant identification number such that when they cross the finish line, the video camera scans their bibs' identification numbers and record their crossing times by capturing the moment when runners cross over the finish line. The position of the finish line can be defined in the field of the view of the camera through “threshold crossing” concepts or even through defining x-y coordinates of the start (e.g., one end) of the line to the x-y coordinates of the end (e.g., the other end) of the line that the field(s) of view of one or more of the cameras (e.g., cameras 354₁-354₂ of FIG. 3B) are showing.

For example, a computing system can use a small Nvidia® computer integrated circuit (IC) capable of loading different AI models (Nvidia makes computer ICs capable of varying processing power). For example, one can use a lower-end computer IC that is capable of loading two different AI models into its graphics processor units (GPUs).

In an embodiment, a first AI model is configured for participant recognition using humanoid detection. This type of model places a corresponding bounding box 304 around each participant within the field of view (FOV) of at least one of the video cameras.

The second AI model is configured for optical character recognition (OCR), and performs OCR on each of the participants around which the first AI model places a bounding box 304, for example, by scanning and recognizing the participant identification number on the participant's bib 306.

Sometimes events, such as running races, with a smaller number of participants in the trail-running community generally do not have computer systems or other equipment configured to time runners at the starting line. The event video and gateway system provides only a finish time for each participant, and all the participants receive the official start time of the race as their starting time so each participant can determine his race time. But because not every participant crosses the starting line 112 at the same time at the start of the race, this technique may not be as accurate as a system with gateways 108 at the starting/finish line so that the unique starting and finishing times of each participant can be determined. That is, an embodiment of a system disclosed herein can time one or two runners at a time as runners come in and cross over the finish line with gaps between successive groups of one or more runners.

Each participant's finish-line-crossing moment can be captured as an image or video and saved as an image.

An AI engine can record the finish-line-crossing time of each participant around which the engine generates a bounding box 304 such that every finisher can receive an accurate finish-line-crossing time. If the system fails to optically scan, using OCR, a participant identification number from a bib 306 of a participant, then the system records the participant as an unknown participant, or a participant with an unknown or unobtained participant-identification number.

In an embodiment wherein Bluetooth® tracking technology (e.g., Bluetooth® beacons) is used at the same race, a Bluetooth® signal from the bib/beacon 306 of each participant can provide, to the AI computing system, the participant identification number on the bibs/beacons of the finishers for which the video system did not recognize the participant identification number.

Consequently, in an embodiment, data from the AI computer system can include the unique participant identification number from each of the participant's bibs or beacons and the finish-line-crossing time of each participant.

The AI computer system either can send this data to the cloud where it can be stored, e.g., onto Google® sheets or a website, or can send this data to where it can be ranked to show a multitude of views of the event (e.g., running race) finishers.

Or the AI computer system can be a 100% local system whereby the race director or a human timer supplies a laptop or other computing system for saving information from the AI computer system.

As described herein, such an OCR system can omit RFID tags, Bluetooth® or Wi-Fi® beacons, or any electronic device configured for attachment to an event participant, and still function to identify and time event participants. For example, such an OCR system can be a low-end solution for those who do not want to spend money purchasing one-time-use beacons/tags that are disposed after each event (e.g., a running race).

FIG. 3B is an isometric view 348 of the finish line 112 of FIGS. 1 and 3A, a video system 350 that includes multiple (two in this example) video-camera assemblies 352₁-352₂ each including at least one video camera 354₁-354₂, and multiple (two in this example) finish-line gateways 108₁-108₂, according to an embodiment.

Other than including multiple video-camera assemblies 352₁-352₂, the video system 350 can be similar to the video system 110 of FIG. 1. A reason for the video system 350 including multiple video-camera assemblies 352 is that if multiple participants 302 (only one participant 302 visible in FIG. 3B) cross the finish line 112 at, or approximately at, the same time, one or more participants may partially or fully block another participant from a single video camera's field of view such that the video system cannot take a suitable video or still image of the other participant or of his bib. But with two or more video-camera assemblies 352, the likelihood of one or more participants 302 partially or fully blocking another participant from the field of view of all of the cameras is significantly reduced. That is, there is a strong likelihood that each participant is unblocked from, and, therefore, fully exposed within, the field of view of at least one of the video cameras 354 of at least one of the video-camera assemblies 352.

Similarly, a reason for including multiple (for example two) gateways 108 is that if multiple participants 302 (only one participant 302 visible in FIG. 3B) cross the finish line 112 at, or approximately at, the same time, one or more participants may partially or fully block a single gateway 108 from signaling another participant's beacon (not visible in FIG. 3B) or from receiving the signal emitted by the other participant's beacon such that the single gateway cannot record the other participant's identity, finish time, or other-participant-related data. But with two or more gateways 108, the likelihood of one or more participants 302 partially or fully blocking all of the gateways from communicating with the beacon worn by another participant is significantly reduced. That is, there is a strong likelihood that communications are unblocked between the respective beacon of each participant and at least one of the gateways 108.

Yet another reason for including multiple (for example two) gateways 108 is to detect when a participant crosses the finish line 112. For example, one gateway 1081 can generate an optical beam over and in alignment with the finish line and another gateway 1082 can receive the optical beam. When a participant “breaks” the optical beam with his body as he crosses the finish line 112, the other gateway 1082 detects this break, can record the time of the break as the time that the participant crosses the finish line, and can provide this finish-line-crossing time to a computing circuit to facilitate the computer circuit identifying the participant and matching the participant to his event-finish time as disclosed herein.

In an embodiment, the gateway 1082 can generate, and send to the video-camera assemblies 352, common or separate signals in response to detecting a participant crossing the finish line 112, and the video-camera assemblies can capture an image of the participant crossing the finish line in response to the signal(s) such that image is captured as the participant crosses the finish line.

In another embodiment, the video-camera assemblies 352 can be configured to detect a participant crossing the finish line 112, to determine the time of the finish-line crossing, and to capture an image of the participant in response to detecting the participant crossing the finish line.

In another embodiment, the video-camera assemblies 352₁ and 352₂ can be configured to capture a continuous stream of video images, and to identify one of the images as being an image of a participant crossing the finish line in response to detecting (or to one or more gateways detecting), a time that the participant crosses the finish line, comparing the finish-line-crossing time to the capture times of the video images, and selecting the image of the participant crossing the finish line as the image having a capture time that is closest to the finish-line-crossing time.

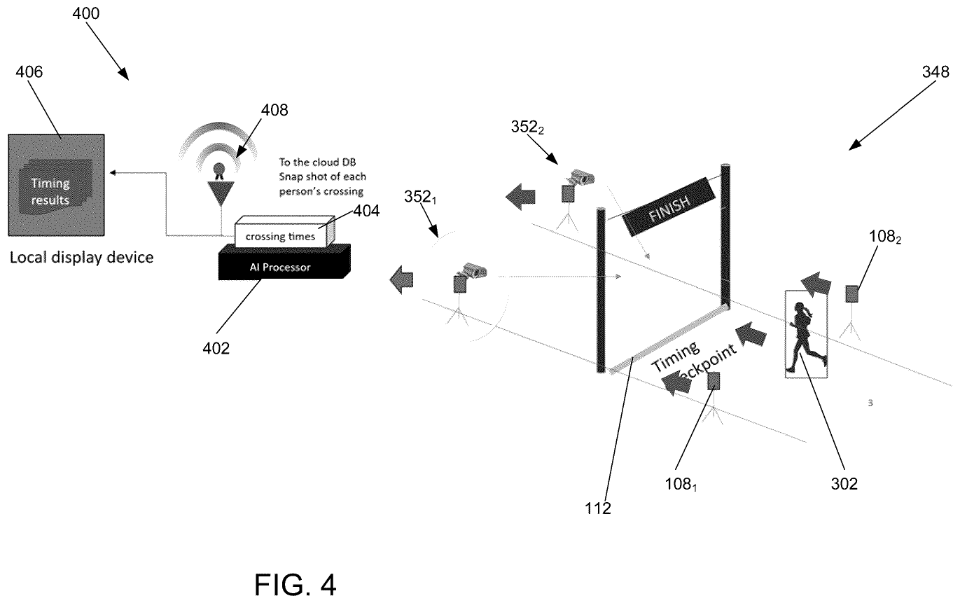

FIG. 4 is the view 348 of FIG. 3B and a computing system 400 with which the video-camera assemblies 352 and the gateways 108 can communicate in a wired or wireless manner, according to an embodiment.

The computing system 400 includes an AI processing circuit (e.g., microcontroller, microprocessor, processor) 402, a database 404 configured to store finishing times (e.g., absolute time and time it took to complete the event course) of the event participants 302, one or more display devices 406, and an antenna, internet connection, or other apparatus 408 configured to couple the computer system to the internet/cloud. Although shown as being outside of the cloud, one or more of the components of the computer system 400 can be implemented in the cloud.

The video-camera assemblies 352 and the start/finish-line gateways 108 are configured to capture data as described herein and to provide the captured data to the computing system 400 in a wired or wireless manner (indicated by the heavy arrows).

For example, the AI processor 402 can store the participant event-finishing times in the database 404, which can provide these times to the one or more display devices 406 for local display to the event participants and attendees. For example, the database 404 can store, and the one or more display devices 406 can display, not only a corresponding event time for each participant 302, but other information such as leg/split times, weather conditions, or participant sex, age, identification, or event ranking (e.g., derived from data for multiple similar yet prior events in which the participant participated).

The AI processor 402 also can store the videos and images of the participants 302 as they cross the finish line 112 in the database 404 or in the cloud for sale to, or otherwise for retrieval by, the participants, or can provide these videos or images for display by the one or more display devices 406.

Furthermore, the AI processor 402 can predict “what ifs” as described herein, according to an embodiment. For example, the AI processor 402 can predict how a participant's event time or leg splits would change if the participant lost 10 lbs. or if the course weather were different. Such predictions for a participant 302 can be based not only on data captured by the gateways 102 (FIGS. 1) and 108 and by the video systems 110 (FIGS. 1) and 352 during an event, but also can be based on data of the participant's past-event performances stored in the database 404, in the cloud, or elsewhere.

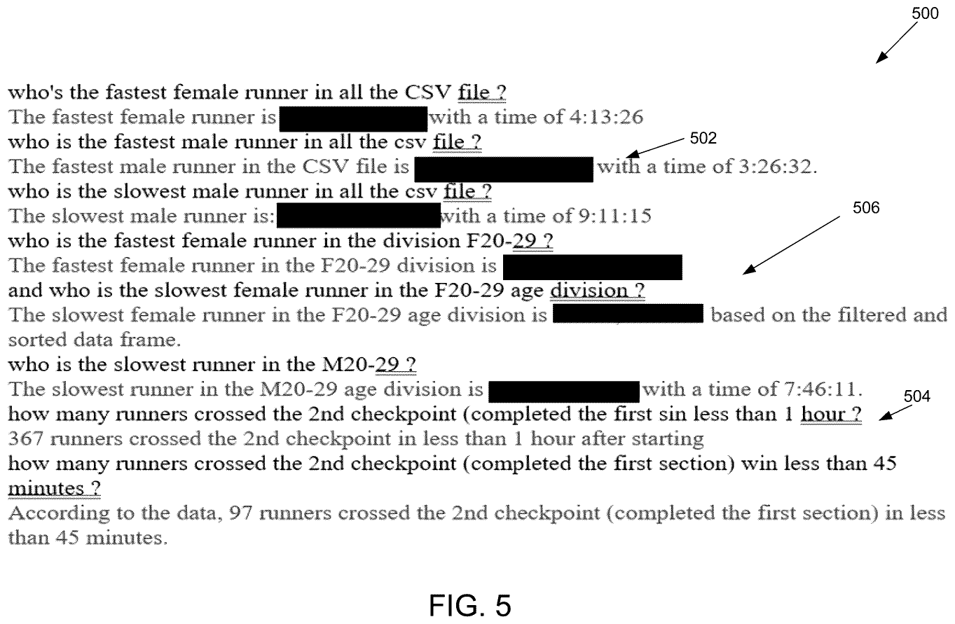

Referring to FIGS. 4-5 , the AI processor 402 can provide or determine information that spans multiple instances of an event (e.g., a 5 k race) based on data captured by the video-camera assemblies 352 and the gateways 102 (FIGS. 1) and 108 for a current occurrence of the event and based on data stored in a database (e.g., database 404 or a cloud database) regarding past occurrences of the event or of one or more similar events.

FIG. 5 is an embodiment of a depiction of basic analytics on the performances of participants in a running-race event generated by an embodiment of an AI system (for example, a system including the AI processor 402 of FIG. 4) using a knowledge base, according to an embodiment.

An AI prompt 500 is configured to tap into a knowledge base (e.g., a database) of results of one or more occurrences of one or more events and to provide analytics and analysis back to a user (e.g., an event participant), according to an embodiment. For example, the AI processor 402 of FIG. 4, or a virtual AI engine in the cloud, can be configured to receive questions in the AI prompt 500, to answer the received questions, and provide the answers in the AI prompt. Or one can submit the questions to the AI processor 402 or AI engine in the cloud via other than the AI prompt 500 and the AI processor or engine can be configured to generate the AI prompt including both the questions and answers to the questions.

For example, at 502, the AI prompt 500 indicates the fastest male runner for a particular event, and his time, over one or more occurrences of the event. At 504, the AI prompt 500 indicates how many runners crossed a particular checkpoint 106 (FIG. 1) of an event course in under one (1) hour over one or more occurrences of the event. And at 506, the AI prompt 500 indicates the slowest female runner in the female age 20-29 division over one or more occurrences of the event.

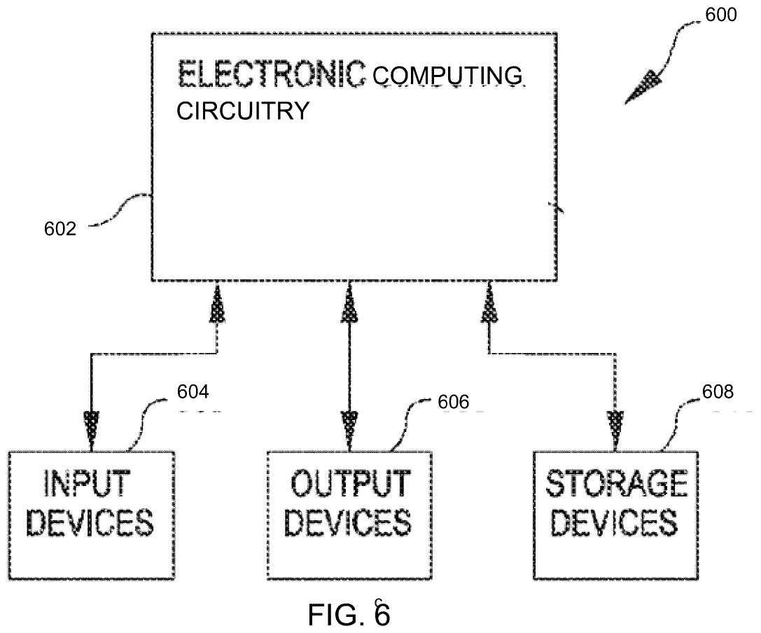

FIG. 6 is a functional block diagram of an electronic system 600, such as an electronic computer system, that can be used as the computer system 400 of FIG. 4 or otherwise can be used to perform one or more of the operations or functions described herein, according to an embodiment. One or more components of the system 600 can be disposed local to the event course (e.g., the running course 102 of FIG. 1) or remote from the event course such as in the cloud.

The system 600 may include electronic computing circuitry 602, according to an embodiment. The electronic computing circuitry 602 may be generally configured to perform various computing functions, which may include, for example, executing specific instructions that may be embodied in software, or performing other specific functions, such as processing data according to the specific instructions, or by other means. For example, the electronic computing circuitry 602 can execute software instructions that cause the electronic computing circuitry, or other circuitry coupled to the electronic computing circuitry, to function or to operate as the AI processor 402 of FIG. 4. Furthermore, the electronic system 600 may also include one or more input devices 604, which may include an audio input device (e.g., one or more microphones) or a manual input device such as a keyboard, a mouse, a tactile input device, or one or more other similar devices, which may be coupled to the electronic circuitry 602 so that user preferences and instructions may be communicated to the electronic computing circuitry 602. The electronic system 600 also can include one or more output devices 606 coupled to the electronic circuitry 602. Suitable output devices 606 may include an audio speaker, a display device, as well as other output devices that may depend on a specific function or configuration of the system 600. One or more data-storage devices 608 also can be coupled to the electronic computing circuitry 602 to permit storage and retrieval of data or instructions from storage media, which may be located within the electronic computing circuitry, or located external to the electronic computing circuitry. Examples of suitable storage devices 608 may include magnetic storage devices, such as hard-disk devices, or floppy disks, tape cassettes, or other similar devices. Other suitable storage devices 608 may include optical storage devices, such as compact disk read-only memory (CDROMs), compact disk read-write (CD-RW) memory devices, digital video disks (DVDs), or solid-state drives or other nonvolatile memory with or without encryption, although other suitable alternatives exist.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A system, comprising:
an image-capture device configured to capture an image of a participant identifier as a participant carrying the participant identifier crosses a finish line of an event course; and
a computing circuit configured
to determine, in response to the captured image of the participant identifier, an identity of the participant, and
to store in a memory
the determined identity of the participant, and
a time at which the participant crossed the finish line.

2. The system of claim 1 wherein the image-capture device includes a video camera configured to capture video images including the image of the participant identifier.

3. The system of claim 1 wherein the image-capture device is configured to capture the image of the participant identifier as the participant wearing the participant identifier crosses the finish line.

4. The system of claim 1 wherein image-capture device is configured to capture the image of the participant identifier as the participant wearing a bib on which the participant identifier is disposed crosses the finish line.

5. The system of claim 1 wherein the computing circuit is configured to perform optical character recognition on the captured image to determine the identity of the participant.

6. The system of claim 1 wherein the computing circuit is configured to read, optically, the participant identifier in the captured image to determine the identity of the participant.

7. The system of claim 1, further comprising a gateway configured to determine the time at which the participant crossed the finish line and to provide the time to the computing circuit.

8. The system of claim 1, further comprising a gateway configured to detect the participant crossing the finish line.

9. The electronic system of claim 8 wherein the image-capture device is configured to capture the image of the participant identifier in response to the gateway detecting the participant crossing the finish line.

10. The electronic system of claim 1 wherein:
the image-capture device is configured to capture the image of a face of the participant as the participant crosses the finish line; and
the computing circuit is configured to store the captured image in the memory.

11. The system of claim 1, further comprising:
a gateway configured to receive the participant identifier from a beacon carried by the participant; and
wherein the computing circuit is configured to determine the identity of the participant in response to the participant identifier received by the gateway.

12. The system of claim 1 wherein at least one of the computing circuit or the memory are instantiated in the cloud.

13. A method, comprising:
capturing an image of a participant identifier as a participant carrying the participant identifier crosses a finish line of an event course;
determining, with a computer circuit in response to the captured image of the participant identifier, an identity of the participant; and
storing, in an electronic memory,
the determined identity of the participant, and
a time at which the participant crossed the finish line.

14. The method of claim 13 wherein capturing the image includes capturing a sequency of video images including the image.

15. The method of claim 13 wherein capturing the image includes capturing the image of the participant identifier as the participant wearing the participant identifier crosses the finish line.

16. The method of claim 13 wherein capturing the image includes capturing the image of the participant identifier as the participant wearing a bib on which the participant identifier is disposed crosses the finish line.

17. The method of claim 13 wherein determining the identity of the participant includes performing, with the computer circuit, optical character recognition on the captured image.

18. The method of claim 13 wherein determining the identity of the participant includes optically reading the participant identifier in the captured image.

19. The method of claim 13, further comprising determining the time at which the participant crossed the finish line and providing the time to the computing circuit with a gateway disposed at, or approximately at, the finish line.

20. The method of claim 13, further comprising detecting the participant crossing the finish line.

21. The method of claim 13 wherein capturing the image comprises capturing the image in response to detecting the participant crossing the finish line.

22. The method of claim 13, further comprising:
wherein capturing the image includes capturing the image of the participant as the participant crosses the finish line; and
storing the captured image in the electronic memory.

23. The method of claim 13, further comprising:
receiving, wirelessly, the participant identifier from a beacon carried by the participant; and
determining the identity of the participant in response to the participant identifier received from the beacon if the identity of the participant is not determined in response to the captured image.

24.-58. (canceled)

59. A tangible, non-transitory computer-readable medium storing instructions that, when executed by a processor, cause the processor to:
capture an image of a participant identifier as a participant carrying the participant identifier crosses a finish line of an event course;
determine, in response to the captured image of the participant identifier, an identity of the participant; and
store, in electronic memory
the determined identity of the participant, and
a time at which the participant crossed the finish line.
